(19) United States
(12) Patent Application Publication
(10) Pub. No.: US 2017/0352113 A1
(43) Pub. Date: Dec. 7, 2017

(54) PERSONAL LIFE DISRUPTION INDICATOR

(71) Applicant: International Business Machines Corporation, Armonk, NY (US)

(72) Inventors: John V. Delaney, Meath (IE); Mickey Iqbal, Plano, TX (US); Nadeem Malik, Austin, TX (US); Niambh Scullion, Dublin (IE); Clea A. Zolotow, Key West, FL (US)

(21) Appl. No.: 15/172,822

(22) Filed: Jun. 3, 2016

(51) Int. Cl. G06Q 50/14; G01S 19/14; G06F 17/27; G06Q 10/10

(52) U.S. Cl. CPC G06Q 50/14; G06Q 10/10; G01S 19/14; G06F 17/271

(57) ABSTRACT

An approach to generating a disruption indicator for an employee. The approach parses communication feeds into a collection of verbs and subjects. The approach then uses a lookup to determine if the verbs match actions associated with stressful situations. Further, the approach determines the location of the employee based on GPS coordinates to aid in measuring a stressful situation. The approach then stores the data for further analysis and generates a disruption indicator for the employee. The approach can also tune the disruption indicator by weighting the assessment of the stressful situation with the employee's biometric data from the time of the stressful situation.

### BACKGROUND OF THE INVENTION

The present invention relates generally to management of employee utilization and more specifically, to employee utilization management based on a personal life disruption indicator.

Employees assigned to client locations regularly face challenges with disruptions to their work schedules and travel arrangements. A wide variety of issues comprising clients changing plans at the last minute, changing project commitments and/or requirements, airport issues, rental car issues, hotel accommodation issues, airline delays and cancellations, weather issues, troublesome routes and connections, traffic congestion, etc. cause these employee disruptions.

This collection of disruptions and frustrations can have a profound negative impact on an employee's ability to perform as required by the employer at the client site. Further, the lost time associated with these disruptions is usually recovered from the employee's personal time and accordingly, can have a detrimental impact on the employee's health and wellbeing as well as a negative impact on the employee's family life and home life.

### SUMMARY

According to an embodiment of the present invention, a method for creating a disruption indicator based on communication feeds, the method comprising: receiving, by a disruption indicator component, one or more communication feeds associated with an employee; parsing, by the disruption indicator component, the one or more communication feeds into a collection of verbs and subjects, wherein the subjects are associated with the verbs, respectively; determining, by the disruption indicator component, a subset of verbs and subjects in the collection of verbs and subjects, wherein the subset of verbs and subjects match words in a lookup dictionary; pairing, by the disruption indicator component, the subset of verbs and subjects with Global Positioning System (GPS) data associated with the subset of verbs and subjects, respectively; storing, by the disruption indicator component, the GPS data and the subset of verbs and subjects; and creating, by the disruption indicator component, a disruption indicator based on the GPS data and the subjects associated with the subset of verbs and subjects.

According to another embodiment of the present invention, a computer program product for creating a disruption indicator based on communication feeds, the computer program product comprising: one or more non-transitory computer readable storage media and program instructions stored on the one or more non-transitory computer readable storage media, the program instructions comprising: program instructions to receive, by a disruption indicator component, one or more communication feeds associated with an employee; program instructions to parse, by the disruption indicator component, the one or more communication feeds into a collection of verbs and subjects, wherein the subjects are associated with the verbs, respectively; program instructions to determine, by the disruption indicator component, a subset of verbs and subjects in the collection of verbs and subjects, wherein the subset of verbs and subjects match words in a lookup dictionary; program instructions to pair, by the disruption indicator component, the subset of verbs and subjects with Global Positioning System (GPS) data associated with the subset of verbs and subjects, respectively; program instructions to store, by the disruption indicator component, the GPS data and the subset of verbs and subjects; and program instructions to create, by the disruption indicator component, a disruption indicator based on the GPS data and the subjects associated with the subset of verbs and subjects.

According to another embodiment of the present invention, a computer system for creating a disruption indicator based on communication feeds, the computer system comprising: one or more computer processors; one or more non-transitory computer readable storage media; program instructions stored on the one or more non-transitory computer readable storage media for execution by at least one of the one or more computer processors, the program instructions comprising: program instructions to receive, by a disruption indicator component, one or more communication feeds associated with an employee; program instructions to parse, by the disruption indicator component, the one or more communication feeds into a collection of verbs and subjects, wherein the subjects are associated with the verbs, respectively; program instructions to determine, by the disruption indicator component, a subset of verbs and subjects in the collection of verbs and subjects, wherein the subset of verbs and subjects match words in a lookup dictionary; program instructions to pair, by the disruption indicator component, the subset of verbs and subjects with Global Positioning System (GPS) data associated with the subset of verbs and subjects, respectively; program instructions to store, by the disruption indicator component, the GPS data and the subset of verbs and subjects; and program instructions to create, by the disruption indicator component, a disruption indicator based on the GPS data and the subjects associated with the subset of verbs and subjects.

### BRIEF DESCRIPTION OF THE DRAWINGS

FIG. 1 is a functional block diagram generally depicting a disruption indicator generation environment, in accordance with an embodiment of the present invention;

FIG. 2 is a functional block diagram depicting a disruption indicator component, in accordance with an embodiment of the present invention;

FIG. 3A,B are flowcharts depicting operational steps of a method for the generation of a disruption indicator, within a disruption indicator generation environment, in accordance with an embodiment of the present invention; and

FIG. 4 is a block diagram of components of a prototype generation computer and a user prototype execution computer of an application prototype generation computing environment, in accordance with an embodiment of the present invention.

### DETAILED DESCRIPTION

The embodiments depicted and described herein recognize that long term travel associated with employment can be stressful and travel fatigue can affect different people in different ways. Further, disruptions in travel plans can cause undue stress on employees and negatively impact the operations of a business. The embodiments depicted and described herein recognize the benefits of generating a disruption indicator based on analyzing various internal and external communication feeds associated with an individual. The embodiments described herein can measure disruptions caused by, for example, transportation systems, communication systems, travel systems and social media trends and generate a disruption indicator.

The disruption indicator can be used to manage work related travel disruptions and provide employers an additional mechanism to reduce the stress of their employees and the organization as a whole. The employer can review the employee's disruption indicator and an employee with a high disruption indicator can be automatically removed from consideration of being assigned to a customer/client who shows a pattern of behavior resulting in requiring an employee to frequently reschedule travel arrangements.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

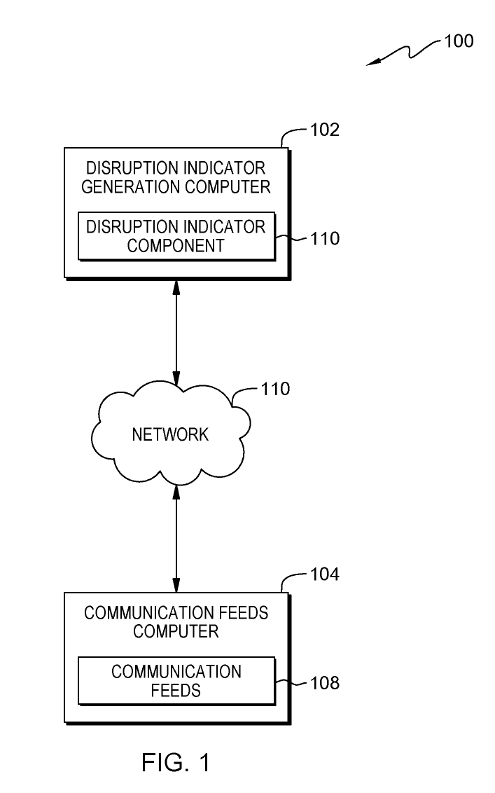

FIG. 1 is a functional block diagram illustrating, generally, an embodiment of a disruption indicator generation environment 100. The disruption indicator generation environment 100 comprises a disruption indicator component 106 operating on a disruption indicator generation computer 102, one or more communication feeds 108 operating on one or more communication feeds computers 104 and a network 110 supporting communications between the disruption indicator generation computer 102 and the one or more communication feeds computers 104.

Disruption indicator generation computer 102 can be a standalone computing device, management server, a web server, a mobile computing device, or any other electronic device or computing system capable of receiving, sending, and processing data. In other embodiments, disruption indicator generation computer 102 can represent a server computing system utilizing multiple computers as a server system. In another embodiment, disruption indicator generation computer 102 can be a laptop computer, a tablet computer, a netbook computer, a personal computer, a desktop computer or any programmable electronic device capable of communicating with other computing devices (not shown) within disruption indicator generation environment 100 via network 110.

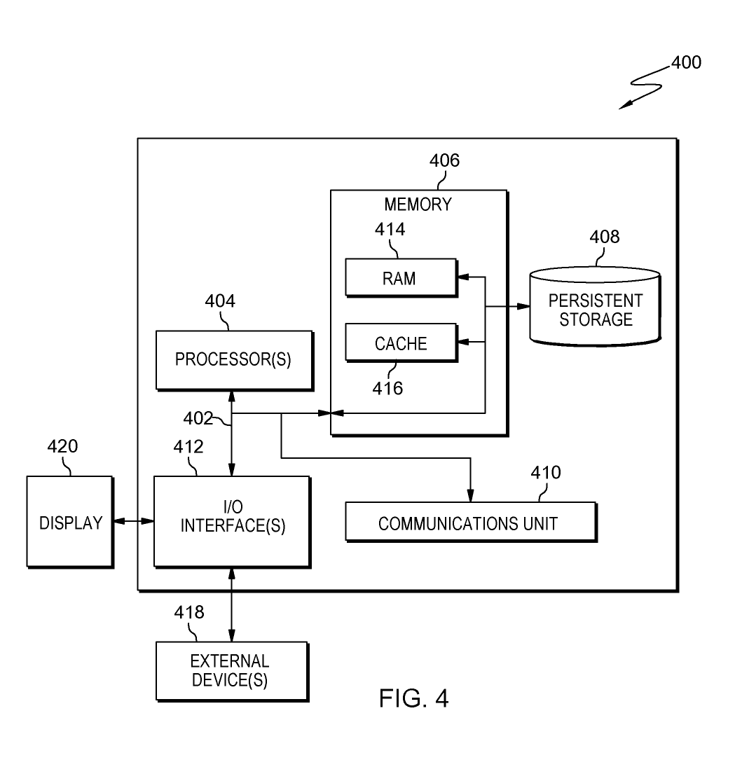

In another embodiment, disruption indicator generation computer 102 represents a computing system utilizing clustered computers and components (e.g., database server computers, application server computers, etc.) that act as a single pool of seamless resources when accessed within disruption indicator generation environment 100. Disruption indicator generation computer 102 can include internal and external hardware components, as depicted and described in further detail with respect to FIG. 4. Disruption indicator component 106 can be a framework for generating a disruption indicator based on parsing communication feeds, associated with an individual. The parsing results in identifying subjects and verbs from the communication feeds wherein the subjects and verbs are related to disruptions of the individuals travel plans. Further, Global Positioning System (GPS) data associated with the location of the individual and biometric data associated with the individual at the time of the disruption is collected and stored.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between prototype generation computer 102 and prototype execution computer 104.

Communication feeds computer 104 can be a standalone computing device, management server, a web server, a mobile computing device, or any other electronic device or computing system capable of receiving, sending, and processing data. In other embodiments, communication feeds computer 104 can represent a server computing system utilizing multiple computers as a server system. In another embodiment, communication feeds computer 104 can be a laptop computer, a tablet computer, a netbook computer, a personal computer, a desktop computer, or any programmable electronic device capable of communicating with other computing devices (not shown) within disruption indicator generation environment 100 via network 110.

In another embodiment, communication feeds computer 104 represents a computing system utilizing clustered computers and components (e.g., database server computers, application server computers, etc.) that act as a single pool of seamless resources when accessed within disruption indicator generation environment 100. Communication feeds computer 104 can include internal and external hardware components, as depicted and described in further detail with respect to FIG. 4. Communication feeds 108 can be, but without limitation, social media feeds, calendar feeds, travel system feeds, telephone feeds and GPS feeds.

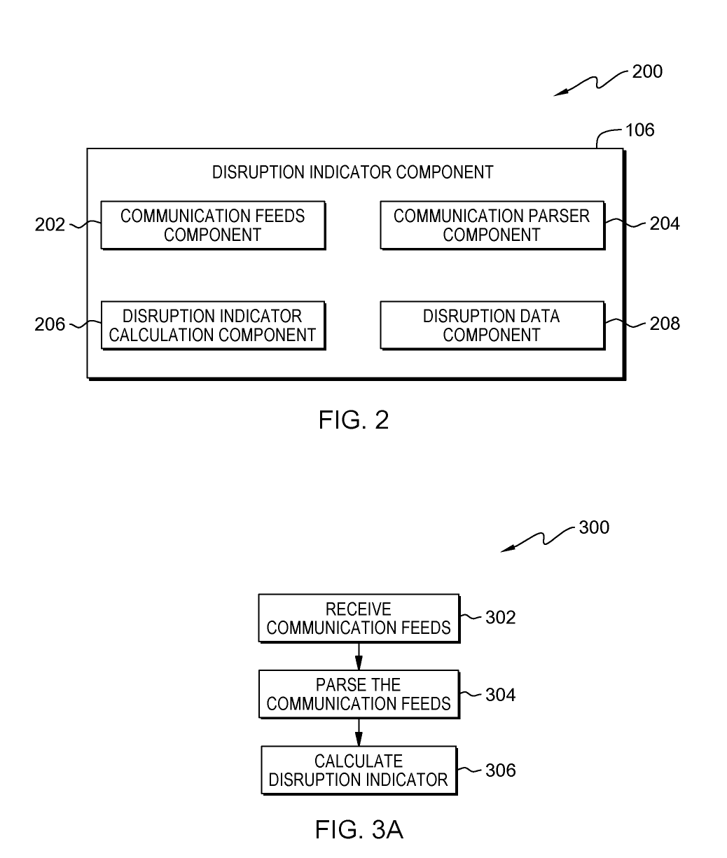

FIG. 2 is a functional block diagram 200 depicting disruption indicator component 106 comprising communication feeds component 202, communication parser component 204, disruption indicator calculation component 206 and biometric/human resources (HR) component 208.

Communication feeds component 202 of an embodiment of the present invention provides the capability to analyze various internal and external communication feeds such as, but not limited to instant messaging, file sharing, travel systems, email systems and telephone systems. It should be noted in the embodiments that the external communication feeds can also be categories of the communication feeds. Communication feeds component 202 collects data from the feeds, cleans the feeds and stores the feeds in a database. The communication feeds component 202 can analyze the subject and if the subject is related to an employee in terms of an event requiring the employee to change their business schedule and/or travel arrangements, then the disruption is marked for further processing related to calculating a disruption indicator.

Communication parser component 204 of an embodiment of the present invention provides the capability to parse the clean feeds for verbs and their associated subjects related to disruptions of the employees day-to-day operations and/or travel arrangements. For example, identifying text in a feed such as “meeting request,” “delay,” “strike,” “rescheduled” and “cancelled” can be marked for further processing based on the subject associated with the verb.

Disruption indicator calculation component 206 provides the capability to calculate a disruption indicator based on the employees work schedule, the employees heart rate variability and other biometric data at the time the disruption occurred and other such factors. Disruption indicator calculation component 206 tracks events such as, but not limited to, the number of occurrences of disruptions, the causes of the disruptions, and the impact of the disruptions over time on the employee. For example, the client repeatedly rearranges the days and times the employee is required to on-site at the client facility. These changes have required the employee to change a Friday afternoon direct flight home to a Saturday afternoon flight with a connection most weekends for the previous 10 months.

The embodiments described herein can calculate the impact on the employee by tracking the additional number of hours travelling and determining a percentage of the trips that are impacted by the changes to previously scheduled travel arrangements. For example, the embodiments can calculate the amount of time the travel disruptions are consuming from the employees evenings and weekends. An embodiment can determine when the disruption level reaches a predetermined threshold and notify the employee's management that intervention is necessary to protect the employee from becoming overly stressed by the client arrangement.

In another aspect, disruption indicator calculation component 206 uses predictive modeling to predict the risk of travel disruption. The predicted risk is then combined with scheduled commitments and work schedule from the employee's calendar to calculate a stress score. For example, the stress score can be on a scale of 1 to 5 wherein 1 is a minor stressful reaction and 5 is a major stressful reaction. It should be noted in the embodiment that the stressful reaction is determined from the biometric data collected at the time of the incident. The stress scores for each incident are aggregated to produce an overall disruption indicator for the employee. It should be noted that analysis of the disruption indicator can identify troublesome clients, risky travel routes and troublesome transportation companies, e.g., airlines, rental car companies, taxi companies, etc. it should further be noted that the stress scores can be weighted based on factors such as, but not limited to biometric data.

In a further aspect of disruption indicator calculation component 206, the embodiments can include projected disruption indicators in the calculation of present disruption indicators. For example, an employer desires to assign an employee to a client, where several employees, in different geographical locations, are under consideration. The embodiments then project a disruption indicator for each employee under consideration based on problematic travel routes. A selection of the best employee to assign to the client is made after consideration of the projected disruption indicator.

In another aspect of disruption indicator calculation component 206, the embodiments can consider disruption indicators associated with past or present clients assigned to a particular employee to calculate a projected disruption indicator before assigning an employee to a new client. This embodiment allows the impact of disruptions based on client behavior to be assigned to the employee in the best position to absorb a new client projected to increase an employee's disruption indicator. It should be noted that these embodiments provide a mechanism for a company to minimize the level of stress experienced by their employees based on travel disruptions and proactively delegate client assignments to increase productivity and minimize stress. Further, the embodiments provide an ability to perform an analysis of the disruptions and generate plans for avoiding similar disruptions in the future for their employees.

Disruption data component 208 provides the capability to store data associated with calculating a disruption indicator. The data comprises biometric data, e.g., heart rate variability data, human resource data, e.g., job title, length of service, etc., personality type data, GPS data and communication feeds data. In another aspect historical disruption indicators can be stored based on employees and disruption trend data associated with clients.

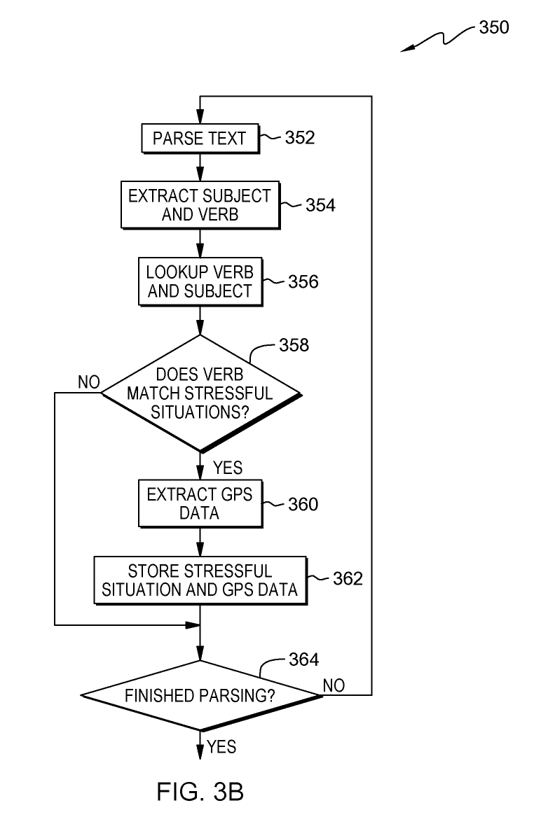

FIGS. 3A and 3B are flowcharts of a method 300, 350 depicting operational steps to calculate a disruption indicator for an employee based on the use of communication feeds associated with the employee. Looking to FIG. 3A, step 302, communication feeds component 202 receives communication feeds associated with the employee, for example, communication feeds component 202 can receive instant messaging feeds (e.g., Twitter by Twitter, Inc., Google+ by Google Inc., Sametime by International Business Machines Corporation, etc.), file sharing feeds (e.g., travel system feeds), email feeds (e.g., emails and work calendars associated with email clients), phone feeds (e.g., call lists with time/date stamps) and GPS feeds (e.g., location at the time of the communication).

Next, at step 304, communication parser component 204 parses the communication feeds collected by step 302 into a collection sentences and identifies a subject and a verb for each sentence. For example, communication parser component can search for words such as, but not limited to “meeting request,” “delay,” “reschedule” and “strike” to identify communications for use in calculating a disruption indicator. Further, GPS data from a GPS feed can be used to identify the location of the employee at the time of the correspondence. For example, at certain times of the year, some regions are prone to sudden air craft controller strikes and if an employee is abroad and scheduled to travel home, the impact of an air craft controller strike on the day the employee is returning home is greater than the impact of the same strike occurring on the day the employee is leaving home for the client location.

Continuing at step 306, disruption indicator calculation component 206 calculates a disruption indicator for an employee based on the parsed communication feeds from step 304. It should be noted, for example, that predictive modeling can be used to predict the risk of travel disruption. Further, the predicted risk of travel disruption can be combined, for example, with calendar commitments and work schedule to generate a stress score. The stress scores for the associated context changes can be aggregated to produce the disruption indicator for the employee.

Looking to FIG. 3B, parsing the communication feeds, step 304, can be further described. Step 352 provides the capability to parse the communication feeds into sentences for further analysis. Next, at step 354, the sentences are parsed for subjects and verbs for further analysis. Continuing, at step 356, the verbs and their associated subjects are looked up, for example, with a dictionary lookup to determine if the verbs match stressful situations. It should be noted in the embodiments that the verbs are identified and an analysis is performed to determine if the verbs are words of interest, in relation to actions associated with disruptive actions and/or stressful situations. Continuing, at step 358, if the verb matches a stressful situation on the lookup then the method 350 continues to step 360 for further processing but if the verb does not match a stressful situation the then method 350 continues to step 364.

Next, at step 360, the method 350 extracts the GPS data from the GPS feed for further processing. It should be noted in the method 350 that the GPS data identifies the location of the employee at the time the stressful situation occurs. Continuing, at step 362, the stressful situation data and the GPS data are stored for further processing. Next, at step 364, if the method 350 has finished parsing the communications feeds then the method 350 continues to step 306 to calculate the disruption indicator. If the method 350 has not finished parsing the communications feeds then the method 350 returns to step 352 to parse the next sentence.

FIG. 4 depicts computer system 400, an example computer system representative of disruption indicator generation computer 102 and communication feeds computer 104. Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for creating a disruption indicator based on communication feeds, the method comprising:
receiving, by a disruption indicator component, one or more communication feeds associated with an employee;
parsing, by the disruption indicator component, the one or more communication feeds into a collection of verbs and subjects, wherein the subjects are associated with the verbs, respectively;
determining, by the disruption indicator component, a subset of verbs and subjects in the collection of the verbs and the subjects, wherein the subset of verbs and subjects match words in a lookup dictionary;
pairing, by the disruption indicator component, the subset of verbs and subjects with Global Positioning System (GPS) data associated with the subset of verbs and subjects, respectively;
storing, by the disruption indicator component, the GPS data and the subset of verbs and subjects; and
creating, by the disruption indicator component, a disruption indicator based on the GPS data and the subjects associated with the subset of verbs and subjects.

2. The method of claim 1, wherein the one or more communication feeds comprise at least one of categories of instant messaging feeds, file sharing feeds, email feeds, phone data feeds and GPS feeds.

3. The method of claim 1, wherein the disruption indicator is based on predictive modeling.

4. The method of claim 3, wherein the predictive modeling generates a risk of travel prediction.

5. The method of claim 4, wherein one or more stress scores are calculated based on factors comprising the risk of travel prediction, calendar commitments and work schedule.

6. The method of claim 5, wherein the disruption indicator is calculated based on aggregating the one or more stress scores, wherein the stress scores are associated with context changes for an employee.

7. The method of claim 6, wherein the one or more stress scores are weighted based on an analysis of biometric data associated with the employee and collected when data associated with the one or more stress scores were generated, respectively.

8. A computer program product for creating a disruption indicator based on communication feeds, the computer program product comprising:
one or more non-transitory computer readable storage media and program instructions stored on the one or more non-transitory computer readable storage media, the program instructions comprising:
program instructions to receive, by a disruption indicator component, one or more communication feeds associated with an employee;
program instructions to parse, by the disruption indicator component, the one or more communication feeds into a collection of verbs and subjects, wherein the subjects are associated with the verbs, respectively;
program instructions to determine, by the disruption indicator component, a subset of verbs and subjects in the collection of the verbs and the subjects, wherein the subset of verbs and subjects match words in a lookup dictionary;
program instructions to pair, by the disruption indicator component, the subset of verbs and subjects with Global Positioning System (GPS) data associated with the subset of verbs and subjects, respectively;
program instructions to store, by the disruption indicator component, the GPS data and the subset of verbs and subjects; and
program instructions to create, by the disruption indicator component, a disruption indicator based on the GPS data and the subjects associated with the subset of verbs and subjects.

9. The computer program product of claim 8, wherein the one or more communication feeds comprise at least one of categories of instant messaging feeds, file sharing feeds, email feeds, phone data feeds and GPS feeds.

10. The computer program product of claim 8, wherein the disruption indicator is based on predictive modeling.

11. The computer program product of claim 10, wherein the predictive modeling generates a risk of travel prediction.

12. The computer program product of claim 11, wherein one or more stress scores are calculated based on factors comprising the risk of travel prediction, calendar commitments and work schedule.

13. The computer program product of claim 12, wherein the disruption indicator is calculated based on aggregating the one or more stress scores, wherein the stress scores are associated with context changes for an employee.

14. The computer program product of claim 13, wherein the one or more stress scores are weighted based on an analysis of biometric data associated with the employee and collected when data associated with the one or more stress scores were generated, respectively.

15. A computer system for creating a disruption indicator based on communication feeds, the computer system comprising:
one or more computer processors;
one or more non-transitory computer readable storage media;
program instructions stored on the one or more non-transitory computer readable storage media for execution by at least one of the one or more computer processors, the program instructions comprising:
program instructions to receive, by a disruption indicator component, one or more communication feeds associated with an employee;
program instructions to parse, by the disruption indicator component, the one or more communication feeds into a collection of verbs and subjects, wherein the subjects are associated with the verbs, respectively;
program instructions to determine, by the disruption indicator component, a subset of verbs and subjects in the collection of verbs and subjects, wherein the subset of the verbs and the subjects match words in a lookup dictionary;
program instructions to pair, by the disruption indicator component, the subset of verbs and subjects with Global Positioning System (GPS) data associated with the subset of verbs and subjects, respectively;
program instructions to store, by the disruption indicator component, the GPS data and the subset of verbs and subjects; and
program instructions to create, by the disruption indicator component, a disruption indicator based on the GPS data and the subjects associated with the subset of verbs and subjects.

16. The computer system of claim 15, wherein the one or more communication feeds comprise at least one of categories of instant messaging feeds, file sharing feeds, email feeds, phone data feeds and GPS feeds.

17. The computer system of claim 15, wherein the disruption indicator is based on predictive modeling.

18. The computer system of claim 17, wherein the predictive modeling generates a risk of travel prediction.

19. The computer system of claim 18, wherein one or more stress scores are calculated based on factors comprising the risk of travel prediction, calendar commitments and work schedule.

20. The computer system of claim 19, wherein the disruption indicator is calculated based on aggregating the one or more stress scores, wherein the stress scores are associated with context changes for an employee and the one or more stress scores are weighted based on an analysis of biometric data associated with the employee and collected when data associated with the one or more stress scores were generated, respectively.
